(19) United States
(12) Patent Application Publication
(10) Pub. No.: US 2007/0198383 A1
(43) Pub. Date: Aug. 23, 2007

(54) METHOD AND APPARATUS FOR DATA CENTER ANALYSIS AND PLANNING

(76) Inventors: James Brian Dow, West Calwell, NJ (US); Russell C. Kurtz, Bradley Beach, NJ (US); Joseph Lackey Craig, Middletown, NJ (US)

Correspondence Address: PATTERSON & SHERIDAN, LLP, Suite 100, 595 Shrewsbury Avenue, Shrewsbury, NJ, 07702, US

(21) Appl. No.: 11/678,418

(22) Filed: Feb. 23, 2007

Related U.S. Application Data
(60) Provisional application No. 60/775,938, filed on Feb. 23, 2006.

(51) Int. Cl. G06Q 40/00

(52) U.S. Cl. 705/35

(57) ABSTRACT

Embodiments of the invention generally provide a method and apparatus for data center analysis and planning. One embodiment of a method for planning future investment in a data center comprising a plurality of data center resources includes estimating a baseline value for future capacity requirements of the data center, based on historical data center resource consumption data, generating one or more adjusted values for the future capacity requirements, by altering one or more assumptions in the historical data center resource consumption data, providing one or more plans by which at least one of the baseline values and the one or more adjusted values can be met and projecting the costs associated with the one or more plans.

### CROSS REFERENCE TO RELATED APPLICATIONS

This application claims the benefit of U.S. Provisional Patent Application No. 60/775,938, filed Feb. 23, 2006, which is herein incorporated by reference in its entirety.

### FIELD OF THE INVENTION

The present invention generally relates to business asset analysis, and more particularly relates to forecasting future data center needs.

### BACKGROUND OF THE INVENTION

Enterprises that rely on significant computing resources typically reserve special space (i.e., data centers) that provides conditioned and often redundant power and air conditioning capability in order to maintain a suitable environment for continuous operation of servers and storage equipment. Data center space can be extremely expensive, so enterprises are typically reluctant to devote more space to a data center than is absolutely necessary. However, since one to two years are often needed to construct these specialized facilities, or even to upgrade an existing facility, it is important to know how much data center space will be needed in the future, and to plan for such investment effectively.

Additionally, there are often several alternatives for obtaining the necessary data center space (e.g., build a new space, rent from a collocation center), so it is important to consider these options and their economic and logistical impacts in deciding on the most appropriate plan.

Therefore, there is a need in the art for a method and apparatus for data center analysis and planning.

### SUMMARY OF THE INVENTION

Embodiments of the invention generally provide a method and apparatus for data center analysis and planning. One embodiment of a method for planning future investment in a data center comprising a plurality of data center resources includes estimating a baseline value for future capacity requirements of the data center, based on historical data center resource consumption data, generating one or more adjusted values for the future capacity requirements, by altering one or more assumptions in the historical data center resource consumption data, providing one or more plans by which at least one of the baseline values and the one or more adjusted values can be met and projecting the costs associated with the one or more plans.

### BRIEF DESCRIPTION OF THE DRAWINGS

So that the manner in which the above recited embodiments of the invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating one embodiment of a method for data center analysis and planning, according to the present invention;

FIG. 2 is a flow diagram illustrating one embodiment of a method for determining baseline future values for an IT inventory, according to the present invention;

FIG. 3 is a flow diagram illustrating one embodiment of a method for generating adjusted projections for future characteristic values, according to the present invention;

FIG. 4 is a flow diagram illustrating one embodiment of a method for estimating the costs of possible data center planning actions, according to the present invention;

FIG. 5 is a flow diagram illustrating one embodiment of a method for selecting a possible action to meet the projected future needs of a data center, according to the present invention;

FIG. 6 is a flow diagram illustrating one embodiment of a method for determining the volatility of a projection of future data center needs, according to the present invention;

FIG. 7 illustrates an exemplary financial model, which includes several future projections; and

FIG. 8 is a high level block diagram of the data center analysis and planning tool that is implemented using a general purpose computing device.

To facilitate understanding, identical reference numerals have been used, where possible, to designate identical elements that are common to the figures.

### DETAILED DESCRIPTION

Embodiments of the invention generally provide a method and apparatus for data center analysis and planning. In one embodiment, the invention projects future data center needs (e.g., future required capacity) and requirements based at least in part on historical data. This projection is combined with a cost model that estimates the relative costs of different strategies for meeting the future needs.

Embodiments of the invention rely on historical and current inventory data for a data center and its components. In one embodiment, relevant data center components or resources for which historical and current inventory is provided include one or more of: standard servers, blade servers, storage equipment (e.g., broken out by frame and terabyte), network switches (as well as network ports utilized), mainframe equipment, telecommunications equipment and all other equipment using data center uninterrupted power supply (UPS) power.

Historical and current inventory data for one or more of the above components is provided as it relates to at least one of the following characterizations: installation date, quantity and type of equipment (e.g., manufacturer and model), unique name, data center location, number of central processing units (CPUs) and CPU speed, number of ports and port speed, business unit (BU) or information technology (IT) infrastructure role, weighting (i.e. how much of the equipment is allocated to the given BU), operating system type, power consumption, space allocation or size (e.g., in terms of rack units), stretched cluster status (i.e., yes or no), status of component (e.g., Dev/Test/QA/Prod, Infra, BCP, UAT, etc.), storage area network identification, DR level (i.e., does the component have a separate hardware back-up?), and closed-form modeling (grid vs. non-grid). In addition, decommission quantities and dates for each component and projections for “offshore” or externally sourced computing are helpful. Some of this information may be model-specific and included in a model lookup table for IT inventory components.

Exemplary outputs of the present invention may include, for example, servers installed, data storage installed, network equipment installed, power consumed, space occupied, total CPU cycles per second (i.e., a measure of total compute power) and data storage usage. Thus, for instance, implementing the present invention, the total power consumed by a data center can be projected into the future to determine when both current and future power capacity for the data center will likely be exhausted.

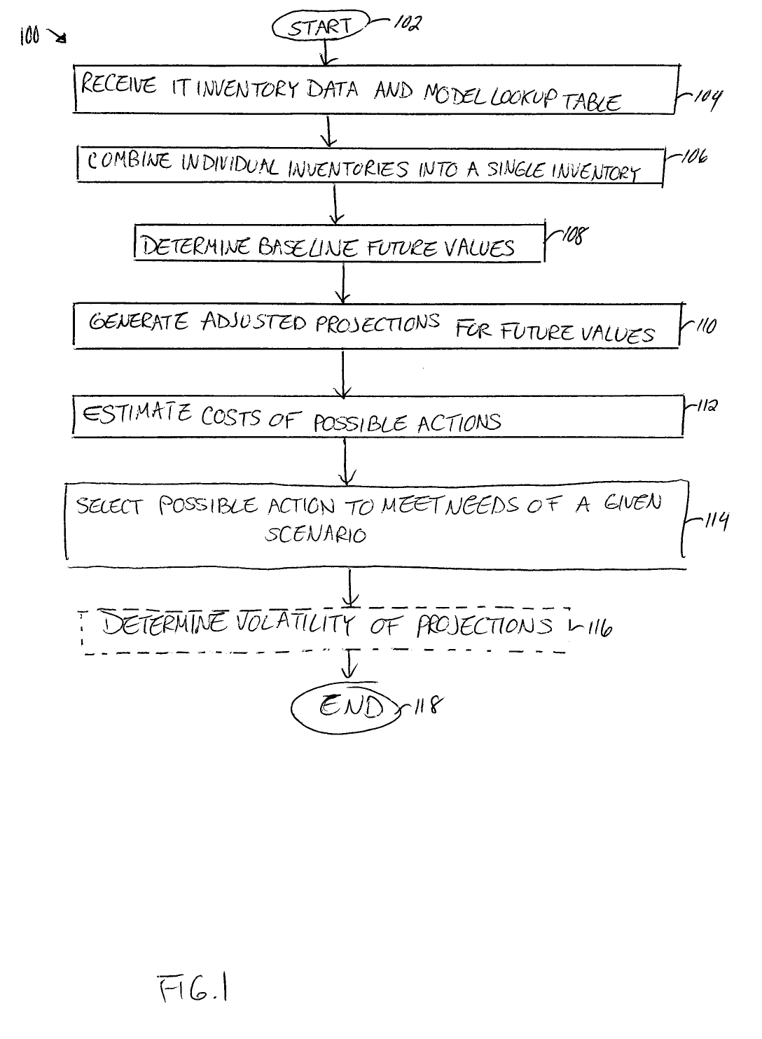

FIG. 1 is a flow diagram illustrating one embodiment of a method 100 for data center analysis and planning, according to the present invention. The method is initiated at step 102 and proceeds to step 104, where the method 100 receives IT inventory data and at least one model lookup table. IT inventory includes IT resources or classes of components that are typically included in a data center (and that require power and cooling), such as servers, networking equipment, storage equipment and the like. Thus, the IT inventory data comprises, for example, install and/or anticipated decommission dates and detailed model information (e.g., vendor, model number, etc.), as described above. The model lookup table(s) describes characteristics of specific components of IT inventory, such as power consumption, size (e.g., in rack units) and the like, as described above.

In step 106, the method 100 combines the individual inventories into a single inventory having a unified format. Typically, IT inventories are given in different formats for different types of equipment or different data centers. The unified format indicates the various items of interest in the IT inventory (for example, manufacturer, model and/or data center location of each component, or specific business unit owning the component, etc.). In one embodiment, this step includes using the model lookup table(s) to populate the inventory with the characteristics of the model of each inventory item. If a model of an IT inventory component does not appear on a current model lookup table, a model lookup table is updated with information for the missing model. In a further embodiment, step 106 includes denoting the current aggregate and individual location use of various characteristics for all classes of inventory (e.g., characteristics of the IT inventory overall, and at individual locations).

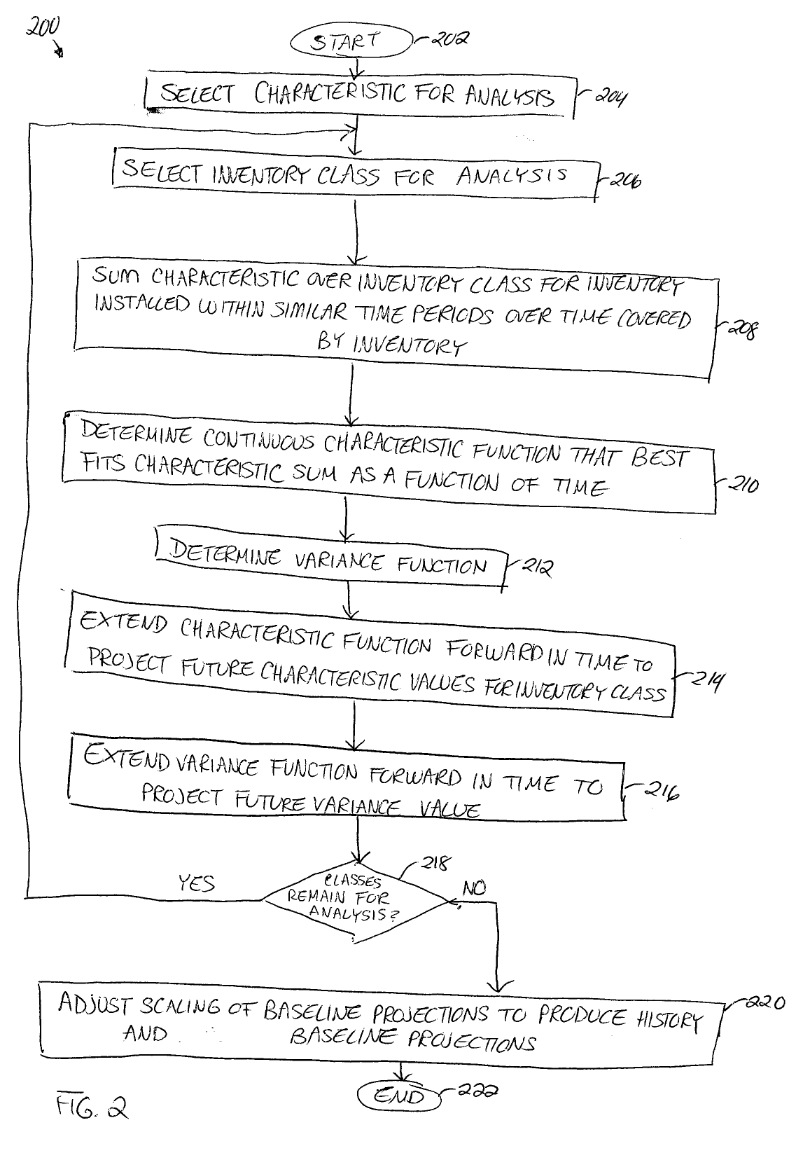

In step 108, the method 100 uses the inventory generated in step 106 to determine baseline future values for the IT inventory. That is, the method 100 uses the current IT inventory information to project the future needs of the IT inventory. One embodiment of a method for determining baseline future values is discussed in greater detail with reference to FIG. 2.

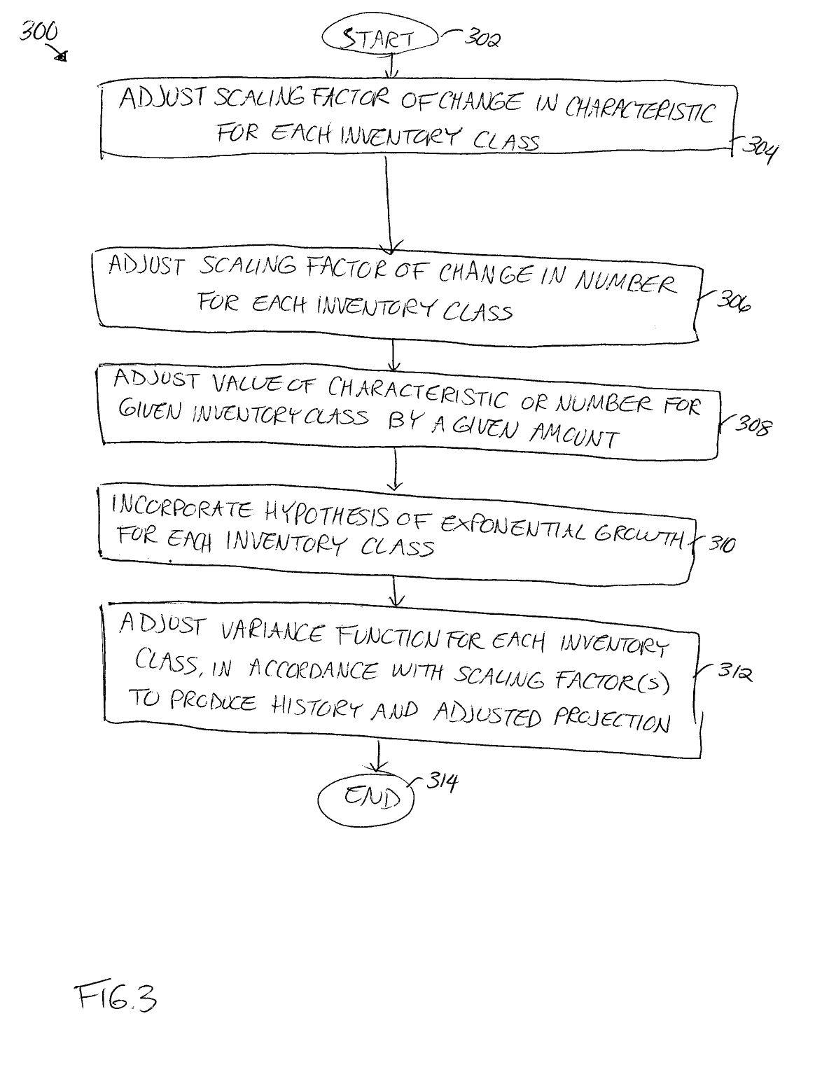

In step 110, the method 100 generates adjusted projections for the future values determined in step 108. That is, the method 100 varies one or more parameters, such as characteristics of IT inventory components, numbers of IT inventory components or the like, in order to account for potential future changes in IT inventory needs (i.e., deviations from the assumptions made to generate the baseline future values). One embodiment of a method for generating adjusted projections is described in greater detail with respect to FIG. 3.

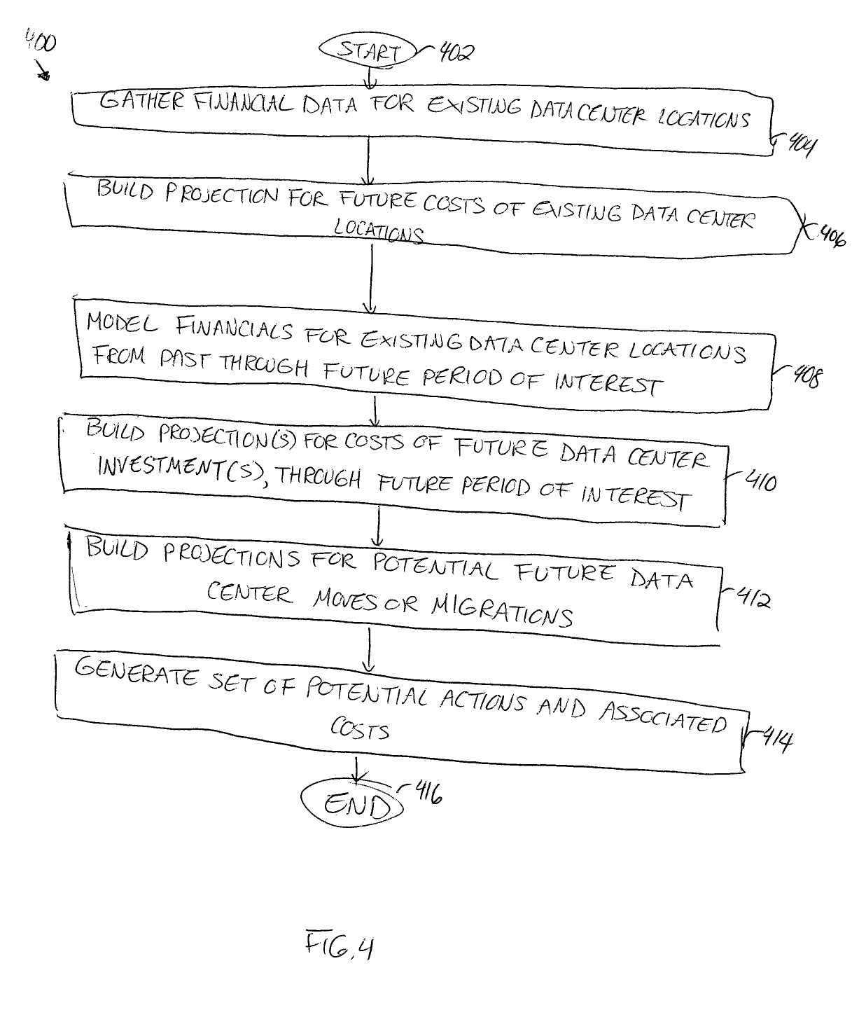

In step 112, the method 100 estimates the costs of possible actions that can address the future data center needs. That is, given specified needs, the method 100 provides one or more plans for meeting the specified needs and an estimate as to how much each plan will cost. One embodiment of a method for estimating the costs of possible actions is discussed in greater detail with respect to FIG. 4.

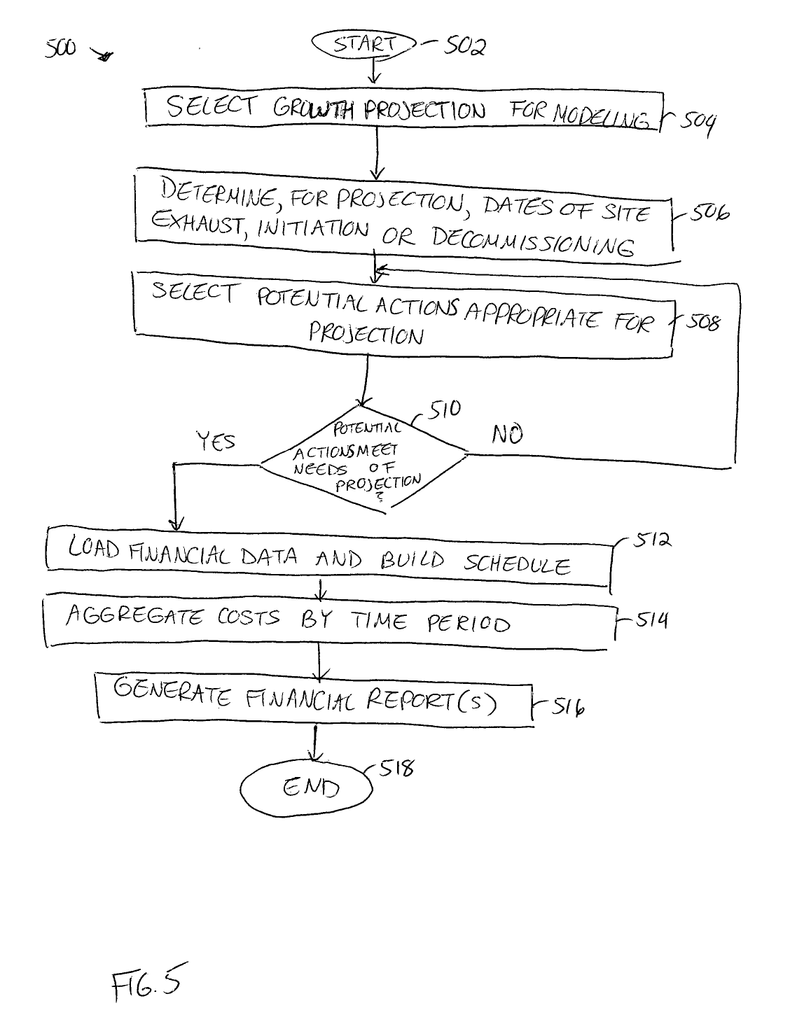

In step 114, the method 100 selects one of the possible actions to meet the needs of a given scenario. That is, given a specific projection (either unadjusted, as in the baseline projection generated in step 108, or adjusted, as in one of the adjusted projections generated in step 110), the method 100 selects one of the possible actions that can meet the needs of the given projection. One embodiment of a method for selecting a possible action is discussed in greater detail with respect to FIG. 5.

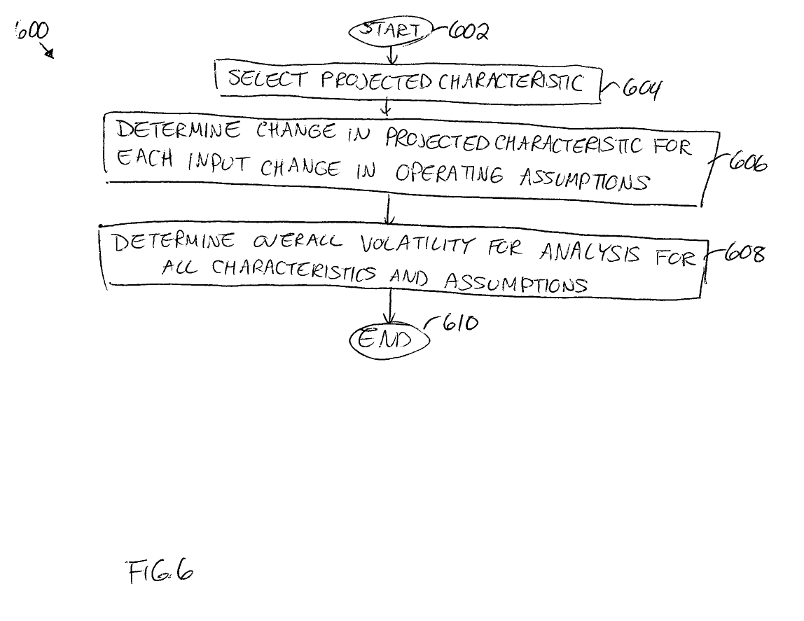

In optional step 116 (illustrated in phantom), the method 100 determines the volatility of the selected projection. The degree of volatility is inversely proportional to the degree of confidence in the projection. One embodiment of a method for determining the volatility of a projection is discussed in greater detail with respect to FIG. 6.

By combining projections of future data center needs and requirements with a cost model that estimates the relative costs of different strategies for meeting the future needs, the method 100 assists enterprises in efficient data center planning. Several potential scenarios for future data center needs can be examined, as well as several strategies (and their associated costs) for addressing each potential scenario. This helps an enterprise to make efficient use of resources dedicated to data center planning.

FIG. 2 is a flow diagram illustrating one embodiment of a method 200 for determining baseline future values for an IT inventory, according to the present invention. The baseline future values represent a “business as usual” control case that projects the likely future data center costs if growth continues under the current prevailing conditions. The method 200 may be implemented, for example, in conjunction with step 108 of the method 100.

The method 200 is initialized at step 202 and proceeds to step 204, where the method 200 selects a characteristic of the IT inventory for analysis. The selected characteristic may be, for example, power consumption. The method 200 then proceeds to step 206 and selects an inventory class for analysis. The selected inventory class may be, for example, all discrete servers. Ultimately, the selected characteristic will be analyzed with regard to each inventory class.

In step 208, the method 200 sums the selected characteristic over the selected class of inventory for inventory that was installed within substantially equally sized periods of time over the time covered by the inventory. Following the examples above, for instance, the method 200 might sum the power consumed by all server equipment installed during a given week for each week covered by the IT inventory. In one embodiment, the sum does not account for equipment of the selected inventory class that was removed during the given time period.

In step 210, the method 200 determines a continuous characteristic function that best fits the sum calculated in step 208 as a function of time. In other words, the method 200 performs curve fitting. For example, the method 200 might determine which second order polynomial has the highest R-squared value when compared to the total power consumed by servers over the time period to be fit.

In step 212, the method 200 determines a variance function that best fits the variance between the selected characteristic and the best fitting characteristic function (i.e., determined in step 210) as a function of time over the time period to be fit. In one embodiment, the best fitting variance function is found using any one or more conventional techniques. In one particular embodiment, the variance function is computed by first determining the value of the variance between the characteristic function and the recorded historic data from the beginning of the time period over which the trend is being determined, to a future time in that time period, Var(T). The variance function in this case is the best linear fit of the variance, Var(T) over the trend time period.

In step 214, the method 200 extends the characteristic function forward in time to project the future value of the selected characteristic for the selected inventory class. The method 200 then proceeds to step 216 and extends the variance function forward in time to project the future value of the variance (and, therefore, the size of the ninety-five percent confidence level, which is substantially equal to 1.96 times the value of the variance).

In step 218, the method 200 determines whether there are any inventory classes that have not been analyzed. If the method 200 concludes in step 218 that there is at least one inventory class remaining to be analyzed, the method 200 returns to step 206 and proceeds as described above to select a next inventory class for analysis.

Alternatively, if the method 200 concludes in step 218 that there are no inventory classes remaining to be analyzed, the method 200 proceeds to step 220 and, if an independent measure of the total selected characteristic is available, adjusts the overall scaling of the history and baseline projections of the selected characteristic, so that the sum calculated in step 208 equals the independent measure. Having produced history and baseline projections for the selected characteristic for each inventory class in the IT inventory, the method 200 concludes in step 222.

FIG. 3 is a flow diagram illustrating one embodiment of a method 300 for generating adjusted projections for future characteristic values, according to the present invention. The method 300 assumes that the current characteristics of a data center may not hold constant into the future, but rather might change with time (for example, according to technology or business changes). That is, the adjusted projections project the likely future data center costs if growth does continue under the current prevailing conditions. The method 300 may be implemented, for example, in conjunction with step 110 of the method 100.

The method 300 is initialized at step 302 and proceeds to step 304, where the method 300 adjusts the scaling factor of a change in a characteristic for each inventory class in an IT inventory. For example, the method 300 might adjust the power increase in adding a server (e.g., due to new processor chips being incorporated on a given date). In one embodiment, several permutations or adjustments are run for each characteristic under analysis.

In step 306, the method 300 adjusts the scaling factor of a change in number for each inventory class in the IT inventory. For example, the method 300 might adjust the increase in number of servers (e.g., due to implementing virtualization of servers starting on a given date). In one embodiment, several permutations or adjustments are run for each inventory class under analysis.

In step 308, the method 300 adjusts the value of a given characteristic or the number of a given inventory class by a given amount. In one embodiment, the adjustment leaves any higher derivatives of the trend unchanged. This adjustment may be made, for example, if a known one-time change is expected that would not otherwise have an effect on the trend. For instance, an enterprise might acquire another company's data center portfolio on a given date.

In step 310, the method 300 incorporates, for each inventory class, a hypothesis of exponential growth. The hypothesis of exponential growth uses a user-selected exponential growth factor, start time and affected percentage of the inventory class. In one embodiment, the user-selected percentage of the inventory class is set to zero, resulting in no additional exponential growth factor. For example, the method 300 may project an increase in the total power of an IT inventory's servers, affecting fifty percent of the servers, starting on a given date.

In step 312, the method 300 adjusts a previously computer variance function for each inventory class, accounting for the scaling factors discussed in steps 304 and 306. This results in an adjustment of the ninety-five percent confidence level in a given characteristic for each inventory class, as well as for the total IT inventory. Having thus produced adjusted projections for a given characteristic, the method 300 terminates in step 314.

FIG. 4 is a flow diagram illustrating one embodiment of a method 400 for estimating the costs of possible data center planning actions, according to the present invention. The method 400 may be implemented, for example, in conjunction with step 112 of the method 100. Thus, the method 400 determines, based on the projected future needs of a data center (and given variations of those needs), how those needs can be met and how much it will cost to meet those needs.

The method 400 is initialized at step 402 and proceeds to step 404, where the method 400 gathers financial data for existing data center locations. In one embodiment, this financial data includes at least one of: location facilities costs (e.g., accounting for depreciation and funding from investment model, lease, taxes, utilities, staff, building repairs and maintenance, one-time costs, etc.), IT physical costs, IT maintenance costs, IT network costs, IT staffing and miscellaneous IT costs (e.g., network costs, projects costs, computing costs, engineering costs, mainframe costs, market data costs, etc.). In one embodiment, the financial data is customized for each data center location and each enterprise based on past and present investments and operational expenses.

In step 406, the method 400 builds a projection for the future costs of the existing data center locations. Specifically, the method 400 projects the past and present investments and operational expenses for the existing data center locations into the future for a future period of interest (e.g., ten to twenty years).

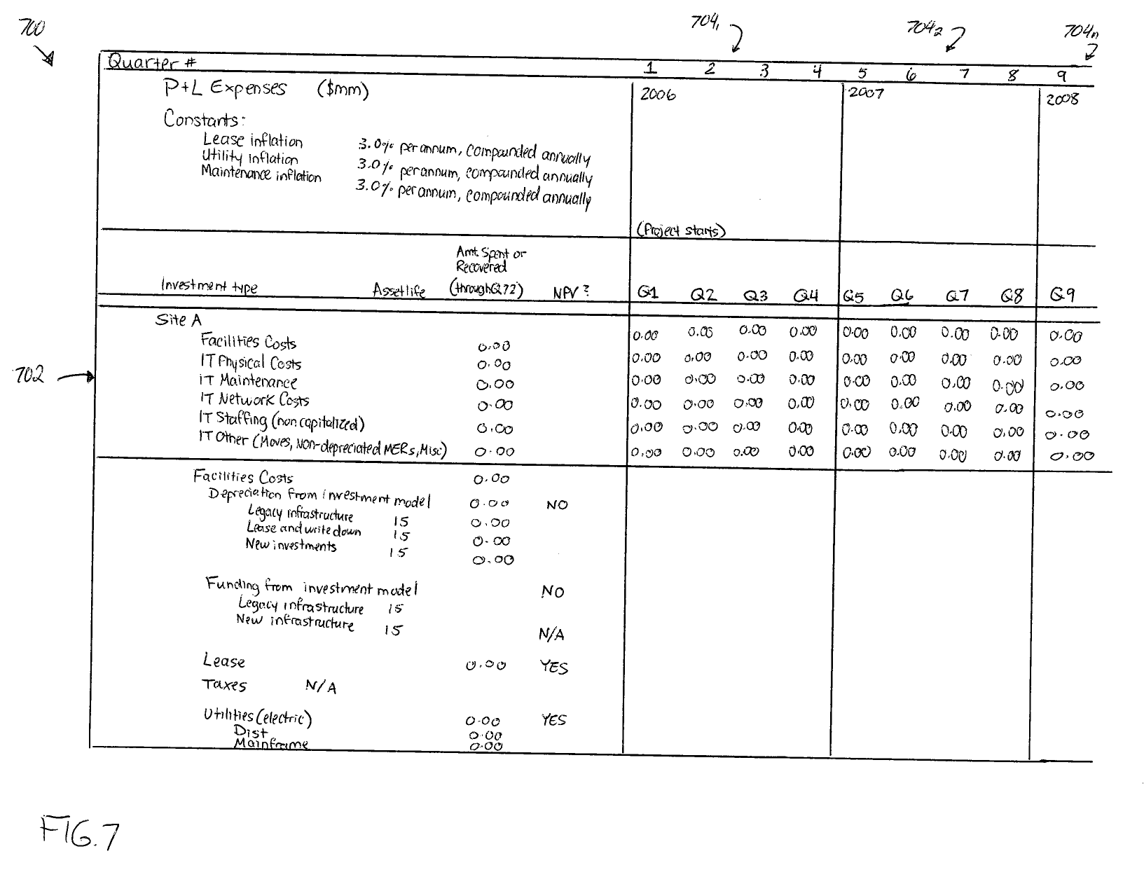

In step 408, the method 400 generates a financial model for the existing data center locations, from the past through the future period of interest, combining the data gathered and projected in steps 404 and 406 (i.e., the expense history and future projections). FIG. 7 illustrates an exemplary financial model 700, which includes a portion of a future projection 702 for a data center location denoted as “Site A”. The projection 702 comprises one or more financial “building blocks”. The columns 704₁-704ₙ (hereinafter collectively referred to as “columns 704”) of the model 700 represent individual years, while quantities in those columns represent itemized expenditures for the projection 702. In the illustrated example, expenditures are broken down by quarter for each year. Thus, for example, the time period for the projection 702 starts in the first quarter of the year 2006 (i.e., Q1) and continues beyond the first quarter of the year 2008 (i.e., Q9).

In step 410, the method 400 builds projections for the costs of future data center investments, through the future period of interest. The alternatives may include, for example, constructing a new space for a future data center, renting space for a future data center from a collocation center, or the like. Then, in step 412, the method 400 builds projections for the costs of potential future data center moves or migrations (i.e., moving costs). In some instances, these costs may be the most difficult to model, particularly if the enterprise has no experience with data center migration activities.

In step 414, the method 400 generates, based on the above projections, a set of possible actions (i.e., future data center plans, such as builds, acquisitions, decommissionings, leases, migrations, moves or the like) and the associated costs for each possible action. That is, all together, the specific data center locations and migrations modeled in steps 408 and 410 represent the set of possible actions. The method 400 then terminates in step 416.

FIG. 5 is a flow diagram illustrating one embodiment of a method 500 for selecting a possible action to meet the projected future needs of a data center, according to the present invention. That is, the method 500 creates a data center strategy from a set of possible actions that have been defined (e.g., by the method 400). The method 500 may be implemented, for example, in conjunction with step 114 of the method 100.

The method 500 is initialized at step 502 and proceeds to step 504, where the method 500 selects a growth projection for modeling. The selected growth projection may be an unadjusted projection (i.e., baseline, for example as in step 108 of FIG. 1) or an adjusted projection (i.e., scaled baseline, for example as in step 110 of FIG. 1).

In step 506, the method 500 determines, for the selected projection, the dates of events including site exhaust, initiation and decommissioning. It should be noted that a major variable in constructing the financial analysis of a data center evolution is the timing of data center projects that are generally required to support (frequently aggressive) growth. This growth may be in the form of server counts, space requirements, power requirements or the like. When specifying the timing of data center builds or expansions, the growth projections (e.g., outputs from the methods 200 and 300) are compared with the capacities of various existing and potential build projects to create a schedule for the data center build projects. In any case, the selected potential action is scheduled based on growth patterns.

The method 500 then proceeds to step 508 and selects a potential set of actions that are appropriate for the selected projection. That is, the method 500 selects a set of possible actions (e.g., as generated by the method 400, described above) that is expected to meet the future data center capacity needs as given by the selected growth projection.

In step 510, the method 500 determines whether the selected potential actions meet the needs of the selected projection. That is, the selected potential actions are validated to ensure that all endemic constraints are satisfied. If the method 500 concludes in step 510 that the selected potential actions do not meet the needs of the selected projection, the method 500 returns to step 508 and proceeds as described above to select alternative potential actions for review.

Alternatively, if the method 500 concludes in step 510 that the selected potential actions do meet the needs of the selected projection, the method 500 proceeds to step 512, where the method 500 loads financial data based on the selected potential action and builds a schedule. Once the schedule of data center build projects is determined, the financial “building blocks” for the different projects can be inserted into a financial model, and adjusted as necessary for inflation, at the appropriate times. This builds a view of investments and expenses to implement a given strategy. For example, a strategy that strives to reduce the number of data center locations through consolidation might make early investments in larger locations and migrate away from smaller locations. On the other hand, the desire to minimize near-term capital expenses might discourage new construction projects and resort to collocation solutions in the near-term.

In step 514, the method 500 aggregates the costs of the selected potential actions by time periods (e.g., by fiscal quarter, fiscal year or the like). This allows total costs, annual budgets and other data to be generated. Referring back to FIG. 7, in one embodiment, aggregation of costs may be accomplished by summing the columns 704 of the model 700.

In step 516, the method 500 generates financial reports (e.g., capital budgets, profit and loss expense streams, net present value, etc.). Key reports might include those that show capital and profit and loss expense streams for each strategy (or set of potential actions), as well as discounted views (e.g., net present value analysis). The different cash flow views for the different potential actions can then be reviewed and compared to determine the most cost-effective alternative(s). The financial results may then be combined with other factors (e.g., qualitative factors) to determine the best all-around data center strategy for an enterprise. The method 500 then terminates in step 518.

FIG. 6 is a flow diagram illustrating one embodiment of a method 600 for determining the volatility of a projection of future data center needs, according to the present invention. The method 600 may be implemented, for example, in accordance with optional step 116 of the method 100. Thus, the method 600 presents a way of “double-checking” the result of steps 104-114 of the method 100.

The method 600 is initialized at step 602 and proceeds to step 604, where the method 600 selects a projected characteristic, Cᵢ. The method 600 then proceeds to step 606 and determines the change in the projected characteristic for each input change in operating assumptions. This analysis yields a value representing the volatility, V_{A}_{ⱼ}^{C}^{ᵢ}, of the projected characteristic, Cᵢ, with respect to a given assumption, Aⱼ. Specifically, the volatility, V_{A}_{ⱼ}^{C}^{ᵢ}, may be expressed as:

$${V}_{{A}_{j}}^{{C}_{i}} ( t ) = \frac{\partial {C}_{i} ( t )}{\partial {A}_{j} ( t )} \qquad ( EQN . 1 )$$

By way of example, the method 600 might determine the change in total power on a given date for a given change in the rate of servers being installed.

In step 604, the method 600 determines the overall volatility for the inventory analysis for all relevant characteristics and assumptions. The overall volatility, V(t), may be expressed as:

$$V ( t ) = \sqrt{{\sum }_{i} {\sum }_{j} {[ {a}_{ij} {V}_{{A}_{j}}^{{C}_{i}} ( t ) ]}^{2}} \qquad ( EQN . 2 )$$

Thus, the overall volatility, V(t), is the square root of the sum of the squares of the specific volatilities multiplied by a weighting factor, aᵢⱼ. Each weighting coefficient aᵢⱼ is separately determined but in the proper units such that all individual terms of the sum of the squares of the specific volatilities will be unitless. Having calculated both the volatilities, V_{A}_{ⱼ}^{C}^{ᵢ}, of the individual characteristics with respect to each assumption (and for each inventory class) and the overall volatility, V(t), the method 600 terminates in step 610.

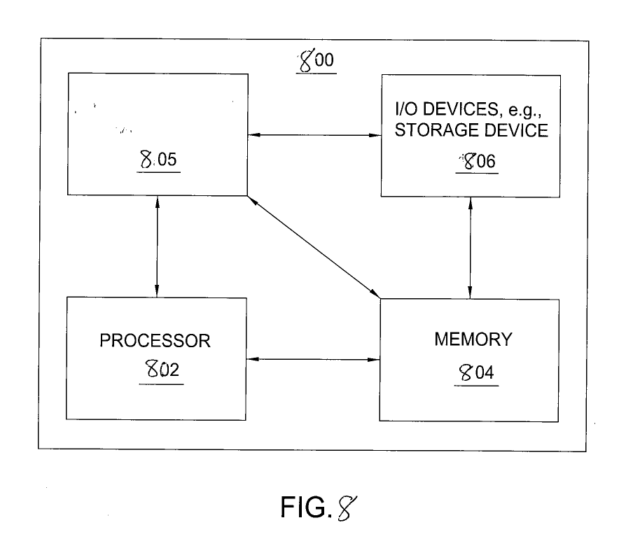

FIG. 8 is a high level block diagram of the data center analysis and planning tool that is implemented using a general purpose computing device 800. In one embodiment, a general purpose computing device 800 comprises a processor 802, a memory 804, an analysis module 805 and various input/output (I/O) devices 806 such as a display, a keyboard, a mouse, a modem, a network connection and the like. In one embodiment, at least one I/O device is a storage device (e.g., a disk drive, an optical disk drive, a floppy disk drive). It should be understood that the analysis module 805 can be implemented as a physical device or subsystem that is coupled to a processor through a communication channel.

Alternatively, the analysis module 805 can be represented by one or more software applications (or even a combination of software and hardware, e.g., using Filed-Programmable Gate Array (FPGA)), where the software is loaded from a storage medium (e.g., I/O devices 806) and operated by the processor 802 in the memory 804 of the general purpose computing device 800. Additionally, the software may run in a distributed or partitioned fashion on two or more computing devices similar to the general purpose computing device 800. Thus, in one embodiment, the analysis module 805 for data center analysis and planning described herein with reference to the preceding figures can be stored on a computer readable medium or carrier (e.g., RAM, magnetic or optical drive or diskette, and the like).

Thus, the present invention represents a significant advancement in the field of business asset analysis. By combining projections of future data center needs and requirements with a cost model that estimates the relative costs of different strategies for meeting the future needs, embodiments of the present invention assist enterprises in efficient data center planning. Several potential scenarios for future data center needs can be examined, as well as several strategies (and their associated costs) for addressing each potential scenario. This helps an enterprise to make efficient use of resources dedicated to data center planning.

While the foregoing is directed to embodiments of the invention, other and further embodiments of the invention may be devised without departing from the basic scope thereof.

What is claimed is:

1. A method for planning future investment in a data center, the data center comprising a plurality of classes of data center resources, the method comprising:
estimating a baseline value for future capacity requirements of the data center, based on historical data center resource consumption data;
generating one or more adjusted values for the future capacity requirements, by altering one or more assumptions in the historical data center resource consumption data;
providing one or more plans by which at least one of the baseline values and the one or more adjusted values can be met; and
projecting costs associated with the one or more plans.

2. The method of claim 1, wherein the plurality of classes of data center resources comprises at least one of: standard servers, blade servers, storage equipment, network switches, mainframe equipment and telecommunications equipment.

3. The method of claim 1, wherein the estimating comprises:
selecting a data center resource characteristic for analysis;
summing, with respect to a given class of data center resources, the selected characteristic over a given time period in order to establish a historical trend for the selected characteristic;
identifying a continuous characteristic function that best fits the historical trend; and
extending the continuous characteristic function forward in time to estimate the baseline value.

4. The method of claim 3, wherein the data center resource characteristic comprises: power consumption or size.

5. The method of claim 3, further comprising:
determining a variance between the historical trend and the continuous characteristic function;
identifying a variance function that best fits the variance over the given time period; and
extending the variance function forward in time to estimate future variance of the baseline value.

6. The method of claim 5, wherein the generating comprises:
adjusting, for at least the given class, a scaling factor, the scaling factor relating to at least one of: a change in the selected characteristic of the given class and a change in a number of components in the given class; and
adjusting the variance function for the given class, in accordance with the scaling factor, to generate the one or more adjusted values.

7. The method of claim 6, further comprising:
incorporating a hypothesis of exponential growth for a given percentage of the given class.

8. The method of claim 6, wherein the projecting comprises:
gathering financial date relating to existing data center locations; and
projecting a cost of future investment in the existing data center locations through a future period of interest, based on the gathered data.

9. The method of claim 8, further comprising:
projecting a cost of migrating at least a portion of the existing data center locations.

10. The method of claim 8, further comprising:
constructing a schedule for the future investment.

11. A computer readable medium containing an executable program for planning future investment in a data center, the data center comprising a plurality of classes of data center resources, where the program performs the steps of:
estimating a baseline value for future capacity requirements of the data center, based on historical data center resource consumption data;
generating one or more adjusted values for the future capacity requirements, by altering one or more assumptions in the historical data center resource consumption data;
providing one or more plans by which at least one of the baseline values and the one or more adjusted values can be met; and
projecting costs associated with the one or more plans.

12. The computer readable medium of claim 11, wherein the plurality of classes of data center resources comprises at least one of: standard servers, blade servers, storage equipment, network switches, mainframe equipment and telecommunications equipment.

13. The computer readable medium of claim 11, wherein the estimating comprises:
selecting a data center resource characteristic for analysis;
summing, with respect to a given class of data center resources, the selected characteristic over a given time period in order to establish a historical trend for the selected characteristic;
identifying a continuous characteristic function that best fits the historical trend; and
extending the continuous characteristic function forward in time to estimate the baseline value.

14. The computer readable medium of claim 13, wherein the data center resource characteristic comprises: power consumption or size.

15. The computer readable medium of claim 13, further comprising:
determining a variance between the historical trend and the continuous characteristic function;
identifying a variance function that best fits the variance over the given time period; and
extending the variance function forward in time to estimate future variance of the baseline value.

16. The computer readable medium of claim 15, wherein the generating comprises:
adjusting, for at least the given class, a scaling factor, the scaling factor relating to at least one of: a change in the selected characteristic of the given class and a change in a number of components in the given class; and
adjusting the variance function for the given class, in accordance with the scaling factor, to generate the one or more adjusted values.

17. The computer readable medium of claim 16, further comprising:
incorporating a hypothesis of exponential growth for a given percentage of the given class.

18. The computer readable medium of claim 16, wherein the projecting comprises:
gathering financial date relating to existing data center locations; and
projecting a cost of future investment in the existing data center locations through a future period of interest, based on the gathered data.

19. The computer readable medium of claim 18, further comprising:
projecting a cost of migrating at least a portion of the existing data center locations.

20. A system for planning future investment in a data center, the data center comprising a plurality of classes of data center resources, the system comprising:
means for estimating a baseline value for future capacity requirements of the data center, based on historical data center resource consumption data;
means for generating one or more adjusted values for the future capacity requirements, by altering one or more assumptions in the historical data center resource consumption data;
means for providing one or more plans by which at least one of the baseline values and the one or more adjusted values can be met; and
means for projecting costs associated with the one or more plans.
